(19) United States
(12) Patent Application Publication
(10) Pub. No.: US 2018/0148007 A1
(43) Pub. Date: May 31, 2018

(54) SYSTEMS AND METHODS FOR ADJUSTING ONE OR MORE VEHICLE SETTINGS

(71) Applicant: Toyota Motor Engineering & Manufacturing North America, Inc., Erlanger, KY (US)

(72) Inventors: Sergei Gage, Redford, MI (US); Nicholas S. Sitarski, Ypsilanti, MI (US); Ida T. Mai-Krist, White Lake, MI (US)

(73) Assignee: Toyota Motor Engineering & Manufacturing North America, Inc., Erlanger, KY (US)

(21) Appl. No.: 15/422,813

(22) Filed: Feb. 2, 2017

Related U.S. Application Data
(60) Provisional application No. 62/427,958, filed on Nov. 30, 2016.

(51) Int. Cl. B60R 16/037; B60N 2/02; B60R 25/01; B60H 1/00

(52) U.S. Cl. CPC B60R 16/037; B60H 1/00642; B60R 25/01; B60N 2/0248

(57) ABSTRACT

A system for adjusting one or more vehicle settings includes one or more processors, one or more occupant recognition sensors communicatively coupled to the one or more processors and configured to output an occupant recognition signal indicative of an identity of one or more vehicle occupants, and one or more memory modules communicatively coupled to the one or more processors. The one or more memory modules store logic that when executed by the one or more processors, cause the one or more processors to: recognize a first vehicle occupant of the one or more vehicle occupants, determine a first vehicle zone in which the first vehicle occupant is present, automatically adjust the one or more vehicle settings based on one or more occupant preference settings associated with the first vehicle occupant and the first vehicle zone.

### CROSS-REFERENCE TO RELATED APPLICATIONS

This application claims the benefit of U.S. Provisional Patent Application No. 62/427,958, filed Nov. 30, 2016, hereby incorporated by reference in its entirety.

### TECHNICAL FIELD

The present specification generally relates to systems and methods for adjusting one or more vehicle settings and, more specifically, systems and methods for automatically adjusting one or more vehicle settings based on recognition of a vehicle occupant.

### BACKGROUND

Vehicles today are often equipped with the ability to allow a driver or other vehicle occupants to adjust multiple vehicle settings to improve comfort. For example, vehicle occupants may adjust seat settings, steering wheel positions setting, pedal position settings, climate settings; entertainment settings, mirror position settings, and the like. However, when multiple people share a vehicle these various settings may not be preset to the individuals preferences. Therefore, the individual may need to individually adjust each of the desired vehicle settings each time they enter the vehicle.

Accordingly, a need exists for alternative systems and methods for adjusting one or more vehicle settings.

### SUMMARY

In one embodiment, a system for adjusting one or more vehicle settings may include one or more processors, one or more occupant recognition sensors communicatively coupled to the one or more processors and configured to output an occupant recognition signal indicative of an identity of one or more vehicle occupants, and one or more memory modules communicatively coupled to the one or more processors. The one or more memory modules store logic that when executed by the one or more processors, cause the one or more processors to: recognize a first vehicle occupant of the one or more vehicle occupants, determine a first vehicle zone in which the first vehicle occupant is present, wherein the first vehicle zone is one of a driver zone, a front passenger zone, and a rear passenger zone, automatically adjust the one or more vehicle settings based on one or more occupant preference settings associated with the first vehicle occupant and the first vehicle zone.

In another embodiment, a system for adjusting one or more vehicle settings may include one or more processors, one or more occupant recognition sensors communicatively coupled to the one or more processors and configured to output an occupant recognition signal indicative of an identity of one or more vehicle occupants, and one or more memory modules communicatively coupled to the one or more processors. The one or more memory modules store logic that when executed by the one or more processors, cause the one or more processors to: recognize a first vehicle occupant of the one or more vehicle occupants, determine a first vehicle zone in which the first vehicle occupant is present, wherein the first vehicle zone is one of a driver zone and a passenger zone, automatically adjust the one or more vehicle settings based on one or more occupant preference settings associated with the first vehicle occupant and the first vehicle zone. When the first vehicle zone is the driver zone, the one or more vehicle settings are adjusted to a first one or more occupant preference settings associated with the first vehicle occupant and the driver zone. When the first vehicle zone is the passenger zone, the one or more vehicle settings are adjusted to a second one or more occupant preference settings associated with the first vehicle occupant and the passenger zone, wherein the first one or more occupant preference settings are different from the second one or more occupant preference settings.

In yet another embodiment, a method for adjusting one or more vehicle settings includes recognizing a first vehicle occupant of one or more vehicle occupants with one or more occupant recognition sensors, determining a first vehicle zone in which the first vehicle occupant is present, wherein the first vehicle zone is one of a driver zone, a front passenger zone, and a rear passenger zone, and automatically adjusting the one or more vehicle settings based on one or more occupant preference settings associated with the first vehicle occupant and the first vehicle zone.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a system for adjusting one or more vehicle settings, according to one or more embodiments shown and described herein;

FIG. 2 depicts a side view of a vehicle indicating a placement of one or more occupant recognition sensors of the system of FIG. 1, according to one or more embodiments shown and described herein;

FIG. 3 schematically depicts an interior of the vehicle of FIG. 2 and a placement of the one or more occupant recognition sensors of the system of FIG. 1, according to one or more embodiments shown and described herein;

FIG. 4 depicts a method of adjusting one or more vehicle settings, according to one or more embodiments shown and described herein; and

FIG. 5 schematically illustrates the interior of the vehicle of FIG. 3 with vehicle occupants positioned therein, according to one or more embodiments shown and described herein.

### DETAILED DESCRIPTION

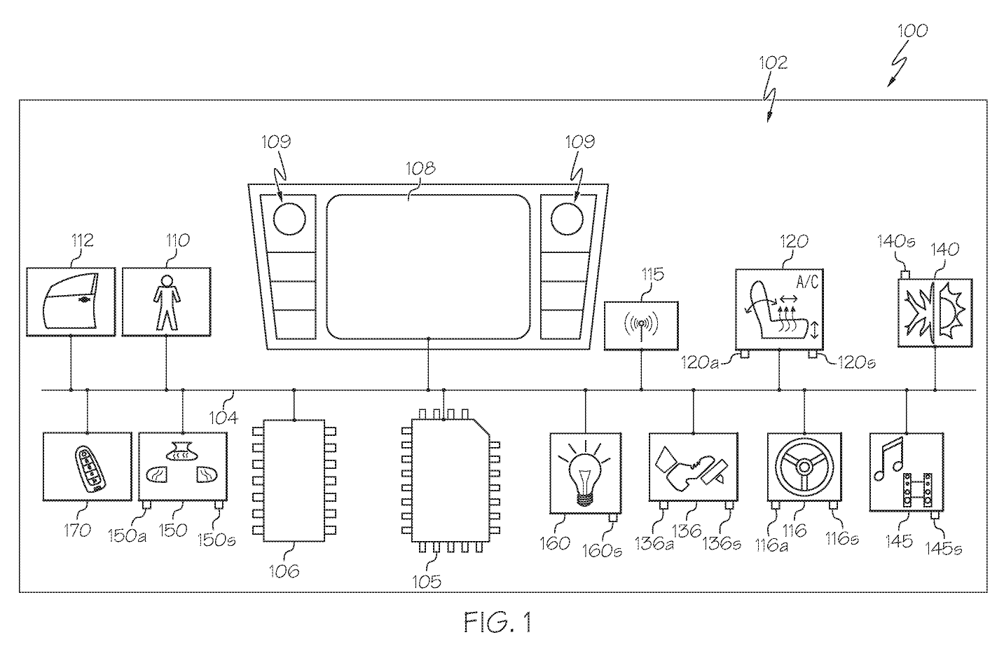

Embodiments disclosed herein include systems and methods for adjusting one or more vehicle settings in response to detecting one or more vehicle occupants. Referring generally to FIG. 1, a system for adjusting one or more vehicle settings includes one or more occupant recognition sensors configured to output an occupant recognition signal indicative of an identity of one or more vehicle occupants. Based on the occupant recognition signal, the system may recognize a first vehicle occupant of the one or more vehicle occupants, determine a first vehicle zone in which the first vehicle occupant is located, and automatically adjust one or more vehicle settings based on one or more occupant preferences settings associated with the first vehicle zone and the first vehicle occupant. In some embodiments, when the first vehicle zone is a driver zone, the one or more vehicle settings are adjusted to a first one or more occupant preference settings associated with the first vehicle occupant and the driver zone. If the first vehicle zone is a passenger zone, the one or more vehicle settings may be adjusted to a second one or more occupant preference settings associated with the first vehicle occupant and the passenger zone. The first one or more occupant preference settings may be different from the second one or more occupant preference settings. As such, one or more occupant preference settings associated with the one or more recognized vehicle occupants and vehicle zones may cause the various vehicle settings to be automatically adjusted to suit the preferences of the one or more vehicle occupants. Furthermore, individualized vehicle settings may be adjusted for each of the one or more vehicle occupants within the determined vehicle zones of the one or more vehicle occupants. The various systems and methods for adjusting one or more vehicle settings will be described in more detail herein with specific reference to the corresponding drawings.

Referring now to the drawings FIG. 1 generally depicts a system 102 of a vehicle 100 for adjusting one or more vehicle settings of a vehicle 100. The system 102 includes a communication path 104, one or more processors 105, one or more memory modules 106, and one or more occupant recognition sensors 110. The system 102 may further include one or more occupant location sensors 115, one or more displays 108, one or more vehicle seats 120; a steering wheel 116, vehicle pedals 136, a climate control system 140, an entertainment control system 145, one or more vehicle mirrors 150, one or more vehicle lights 160, and one or more vehicle status sensors 170. It is noted that, while the vehicle 100 is depicted as an automobile, the vehicle 100 may be any passenger vehicle such as, for example, a terrestrial, aquatic, and/or airborne vehicle. Furthermore, in some embodiments, the vehicle 100 may be an autonomous vehicle.

As described above, the system 102 includes a communication path 104 that provides data interconnectivity between various modules disposed within the system 102. Specifically, each of the modules can operate as a node that may send and/or receive data. In some embodiments, the communication path 104 includes a conductive material that permits the transmission of electrical data signals to processors, memories, sensors, and actuators throughout the system 102. In another embodiment, the communication path 104 can be a bus, such as for example a LIN bus, a CAN bus, a VAN bus, and the like. In further embodiments, the communication path 104 may be wireless and/or an optical waveguide. Components that are communicatively coupled may include components capable of exchanging data signals with one another such as, for example, electrical signals via conductive medium, electromagnetic signals via air, optical signals via optical waveguides, and the like.

The system 102 includes one or more processors 105 communicatively coupled with one or more memory modules 106. The one or more processors 105 may include any device capable of executing machine-readable instructions stored on a non-transitory computer-readable medium. Accordingly, each processor 105 may include a controller, an integrated circuit, a microchip, a computer, and/or any other computing device.

The one or more memory modules 106 are communicatively coupled to the one or more processors 105 over the communication path 104. The one or more memory modules 106 may be configured as volatile and/or nonvolatile memory and, as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the system 102 and/or external to the system 102. The one or more memory modules 106 may be configured to store one or more pieces of logic, as described in more detail below. The embodiments described herein may utilize a distributed computing arrangement to perform any portion of the logic described herein.

Embodiments of the present disclosure include logic stored on the one or more memory modules 106 that includes machine-readable instructions and/or an algorithm written in any programming language of any generation (e.g., 1GL, 2GL, 3GL, 4GL, and/or 5GL) such as, machine language that may be directly executed by the one or more processors 105, assembly language, object-oriented programming (OOP), scripting languages, microcode, etc., that may be compiled or assembled into machine readable instructions and stored on a machine readable medium. Similarly, the logic and/or algorithm may be written in a hardware description language (HDL), such as logic implemented via either a field-programmable gate array (FPGA) configuration or an application-specific integrated circuit (ASIC), and their equivalents. Accordingly, the logic may be implemented in any conventional computer programming language, as pre-programmed hardware elements, and/or as a combination of hardware and software components.

As described above, the system 102 further includes one or more occupant recognition sensors 110. The one or more occupant recognition sensors 110 may be communicatively coupled to the one or more processors 105 over the communication path 104. The one or more occupant recognition sensors 110 may be any sensor configured to output an occupant recognition signal indicative of an identity of one or more vehicle occupants. Based on the occupant recognition signal of the one or more occupant recognition sensors 110, the system 102, based on logic stored on the one or more memory modules 106 and executed by the one or more processors 105, may recognize an identity of one or more vehicle occupants. As will be described in greater detail herein, upon recognizing the one of more vehicle occupants, the system 102 may automatically adjust a variety of vehicle settings based on the recognized vehicle occupant's stored one or more occupant preference settings.

In some embodiments, the one or more occupant recognition sensors 110 may include fingerprint sensors (e.g., capacitance sensors, optical sensors, and the like). The fingerprint sensors may scan a fingerprint of a vehicle occupant of the one or more vehicle occupants when the vehicle occupant comes in contact with or is within a sensing distance of the fingerprint sensors. Based on fingerprint data stored in the one or more memory modules 106 of the system 102, the one or more processors 105 may execute logic to match the scanned fingerprint with a matching fingerprint of a known user of the vehicle 100. For instance, when first entering the vehicle 100, a vehicle occupant may scan his or her fingerprint into the system 102 using a fingerprint sensor and store said fingerprint for later identification of that particular vehicle occupant by the system 102. As such, when the particular vehicle occupant enters the vehicle 100 at a subsequent time and scans his or her fingerprint with the fingerprint sensor the system 102 may, using logic executed by the one or more processors 105, match the scanned fingerprint of the particular vehicle occupant with the particular vehicle occupant's stored fingerprint to identify the particular vehicle occupant.

In addition to or in lieu of fingerprint sensors, the one or more occupant recognition sensors 110 may include one or more facial recognition sensors (e.g., cameras or the like). The one or more facial recognition sensors may be any device having an array of sensing devices (e.g., pixels) capable of detecting radiation in an ultraviolet wavelength band, a visible light wavelength band, and/or an infrared wavelength band. The one or more facial recognition sensors may have any resolution. The occupant recognition signal output by the one or more facial recognition sensors may include image data indicative of the facial features of a vehicle occupant. The system 102 may then, with the one or more processors 105, execute logic to process the image data to match the facial features from the image data with a particular vehicle occupant of the vehicle 100. For instance, when first entering the vehicle 100, a vehicle occupant may cause the system 102 to, or the system 102 may automatically, capture image data of the vehicle occupant using the one or more facial recognition sensors and store the image data of the particular vehicle occupant for later identification of the particular vehicle occupant by the system 102. As such, when the particular vehicle occupant enters the vehicle 100 a subsequent time and the system 102 captures image data of the particular vehicle occupant's facial features, the system 102 may, using logic executed by the one or more processors 105, match the facial features of the particular vehicle occupant with the particular vehicle occupant's stored facial features to identify the particular vehicle occupant.

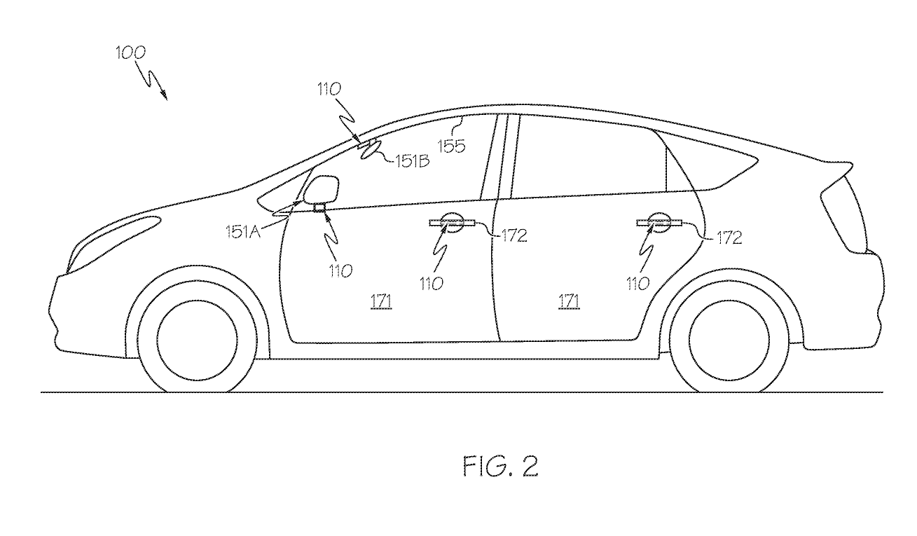

The one or more occupant recognition sensors 110 may be located in a variety of locations within and/or outside the vehicle 100. In some embodiments, where the one or more occupant recognition sensors 110 include fingerprint sensors, the fingerprint sensors may be located in positions often touched or easily touched by the one or more vehicle occupants. Similarly, where the one or more occupant recognition sensors 110 include one or more facial recognition sensors, the facial recognition sensors may be positioned in positions with visibility of a vehicle occupant of the vehicle 100. Referring to FIG. 2, a side view of the vehicle 100 is depicted having one or more occupant recognition sensors 110 attached thereto. As such one or more of the one or more occupant recognition sensors 110 may be placed on an exterior of the vehicle 100. For example, and not as a limitation, the occupant recognition sensors 110 may be placed on a door 171 of the vehicle 100, such as adjacent to or on a door handle 172 of the vehicle 100, and/or on a side mirror 151A of the vehicle 100.

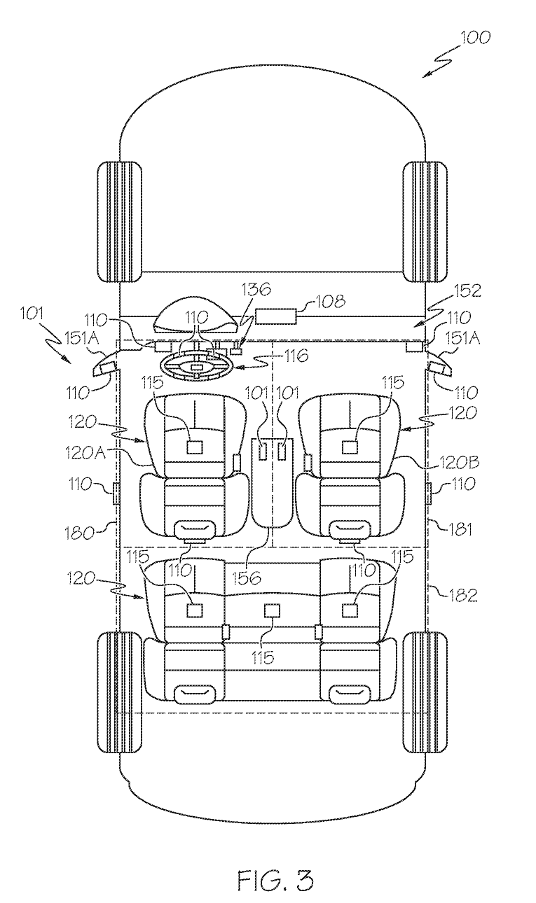

Referring now to FIG. 3 an interior 101 of the vehicle 100 is schematically depicted. The interior 101 depicts a variety of possible locations for the one or more occupant recognition sensors 110. For example, and not as a limitation, the one or more occupant recognition sensors 110 may be placed on or around a steering wheel 116, on a dash board 152, on a center console 156, on a display 108, and/or on the seats 120 of the vehicle 100. In some embodiments, such as wherein the one or more occupant recognition sensors 110 include one or more facial recognition sensors, the one or more occupant recognition sensors 110 may be located toward a ceiling 155 of the vehicle 100, such as shown in FIG. 2, on the steering wheel 116, or on the back of the front vehicle seats 120A and 120B, as shown in FIG. 3.

Referring again to FIG. 1, the system 102 may further include one or more occupant location sensors 115 coupled to the communication path 104 such that the communication path 104 communicatively couples the one or more occupant location sensors 115 to other modules of the system 102. The one or more occupant location sensors 115 may be any sensor that outputs an occupant location signal indicative of the location of the occupant within the vehicle 100. Based on of occupant location signal output by the one or more occupant location sensors 115, the system 102, based on logic executed by the one or more processors 105, may determine a vehicle zone in which the recognized vehicle occupant is located. For example, with reference to FIG. 3, such vehicle zone may include a driver zone 180 and a passenger zone (e.g., a front passenger zone 181, a rear passenger zone 182, and the like). In some embodiments, the occupant location signal output by the one or more occupant location sensors 115 may cause the one or more processors 105 to execute logic to cause the one or more occupant recognition sensors 110 to output the occupant recognition signal to allow the one or more processors 105 to identify various occupants within the vehicle 100. As such, by detecting a vehicle occupant within one of the vehicle zones may start the process of identifying the one or more vehicle occupants.

Referring now to FIG. 2, the one or more occupant location sensors 115 may be located in a variety of locations. For example, and not as a limitation, the one or more occupant location sensors 115 may be weight sensors positioned within the seats 120 of the vehicle 100. As such, when an occupant sits on a weight sensor, a signal may be output to the one or more processors 105 of an occupant being located in the vehicle zone where that particular weight sensor is located. In other embodiments that one or more occupant location sensors 115 may include, but are not limited to, door sensors 112 (shown in FIG. 1) or the like. A door sensor 112 may output a signal indicative of a door of the vehicle 100 being opened or closed. Based on this signal, the system 102, based on logic executed by the one or more processors 105, may determine the door 171 through which a vehicle occupant has entered which may be correlated to a location of the vehicle occupant within the vehicle 100. For example, if a signal is output that the driver's door has opened, the system 102 may determine that there is or will be a vehicle occupant in the driver zone 180. In some embodiments, the one or more occupant location sensors 115 may include a camera, a proximity sensor, or the like.

In some embodiments, information from the one or more occupant recognition sensors 110 may, instead of or in addition to the one or more occupant location signals, also be indicative of an occupant's location within the vehicle 100. For instance, and not as a limitation, the location at which the one or more occupant recognition sensors 110 collects data of the vehicle occupant, might be indicative of the location where the occupant is located within the vehicle. As an example, referring to FIG. 3, if the occupant is recognized from data provided by an occupant recognition sensor 110 located on a steering wheel 116 of the vehicle 100, then the system 102, based on logic executed by the one or more processors 105, may determine that the location of the vehicle occupant is within the driver zone 180 of the vehicle 100. Similarly, if one or more occupant recognition sensors 110 within the front passenger zone 181 outputs an occupant recognition signal, it may be determined that the recognized vehicle occupant is within the front passenger zone 181 of the vehicle 100. If one or more occupant recognition sensors 110 within the rear passenger zone 182 output an occupant recognition signal, it may be determined that the recognized vehicle occupant is within the rear passenger zone 182 of the vehicle 100. As such, a single sensor may act as both a occupant recognition sensor 110 as an occupant location sensor 115. As will be described in greater detail herein, one or more vehicle settings and/or one or more vehicle settings within particular vehicle zones may be adjusted based on one or more occupant preference settings associated with a recognized vehicle occupant(s) and the vehicle zone in which the recognized vehicle occupant is located.

Referring again to FIG. 1, the system 102 may further include a display 108 for providing visual output such as, for example, maps, navigation, entertainment, information, or a combination thereof. The display 108 is coupled to the communication path 104. Accordingly, the communication path 104 communicatively couples the display 108 to other modules of the system 102. The display 108 may include any medium capable of transmitting an optical output such as, for example, a cathode ray tube, light emitting diodes, a liquid crystal display, a plasma display, or the like. Moreover, the display 108 may be a touchscreen that, in addition to providing optical information, detects the presence and location of a tactile input upon a surface of or adjacent to the display 108. Accordingly, each display 108 may receive mechanical input directly upon the optical output provided by the display 108. Additionally, it is noted that the display 108 can include at least one of the one or more processors 105 and the one or more memory modules 106. In some embodiments, the system 102 may include multiple displays located in various zones of the vehicle 100.

The system 102 may include one or more user input devices 109 coupled to the communication path 104 such that the communication path 104 communicatively couples the one or more user input devices 109 to other modules of the system 102. The one or more user input devices 109 may be any device capable of transforming mechanical, optical, or electrical signals into a data signal capable of being transmitted with the communication path 104. Specifically, the one or more user input devices 109 may include any number of movable objects that each transform physical motion into a data signal that can be transmitted to over the communication path 104 such as, for example, a button, a switch, a knob, a microphone or the like. In some embodiments, the display 108 and the one or more user input devices 109 are combined as a single module and operate as an audio head unit or an infotainment system. However, it is noted, that the display 108 and the one or more user input devices 109 may be separate from one another. While the system 102 includes one or more user input devices 109 in the embodiment depicted in FIG. 1, the system 102 may not include one or more user input devices 109 in other embodiments. The one or more user input devices 109 may allow a vehicle occupant to adjust and various vehicle settings as one or more occupant preference settings, in other embodiments, the one or more occupant preference settings may be automatically saved upon adjustment of the one or more vehicle settings by a recognized vehicle occupant. This concept may be more fully understood with discussion of various vehicle preference settings described below.

As noted herein, based on the one or more recognized vehicle occupants, various vehicle and/or vehicle zone settings may be adjusted to the one or more occupant preference settings of the one or more recognized vehicle occupants and may be specific to the particular vehicle zones. Referring still to FIG. 1, the system 102 may further include one or more vehicle seats 120 that are communicatively coupled to the communication path 104 such that the communication path 104 communicatively couples to the one or more vehicle seats 120 to other modules of the system 102. The one or more vehicle seats 120 may provide a variety of adjustable seat settings including but not limited seat height, recline angle, closeness to dashboard, lumbar support position, seat heating, and seat cooling. The one or more vehicle seats 120 may include one or more seat actuators 120a controlled by the one or more processors 105 to allow for adjustment of at least some of these settings. Some embodiments include one or more seat sensors 120s that output signals indicative of the one or more seat settings. During any particular occasion, a recognized vehicle occupant may adjust the various adjustable seat settings. Upon such adjustment, the system 102, based on logic executed by the one or more processors 105 may memorize and save the seat settings set by the recognized vehicle occupant as at least one of the one or more occupant preference settings of the recognized vehicle occupant within the one or more memory modules 106. The particular seat settings may therefore be associated with the recognized vehicle occupant and the particular vehicle zone in which the recognized vehicle occupant has adjusted the seat 120. In other embodiments, the recognized vehicle occupant may need to use the one or more user input devices 109 to manually save the adjusted seat settings as at least one of the one or more occupant preference settings.

In either case, when the particular vehicle occupant re-enters the vehicle 100 at a subsequent time, the system 102, based on logic executed by the one or more processors 105, may, upon recognizing the particular vehicle occupant and determining a vehicle zone of the particular vehicle occupant, may automatically adjust the seat 120 of the particular vehicle occupant to the previously saved seat settings associated with the particular vehicle occupant and the particular vehicle zone by actuating the one more seat actuators 120a of the vehicle seat 120. Hence, different seat settings may be associated with the recognized vehicle occupant for each vehicle zone. For example, when the recognized vehicle occupant is in the driver zone 180, the recognized vehicle occupant may prefer different seat settings than if the recognized vehicle occupant were in one of the passenger zones 181, 182.

The system 102 may further include a climate control system 140 that allows for adjustment of climate settings including, but not limited to, heat, air conditioning, fan speed, scented air, and the like. In some embodiments, the individual vehicle zones (e.g., the driver zone 180, the front passenger zone 181, and the rear passenger zone 182) may each have its own climate control system 140. In some embodiments, each zone may not have its one climate control system 140. In embodiments wherein at least two of the vehicle zones have their own climate control system 140, the one or more recognized vehicle occupants may adjust the climate settings within his or her particular vehicle zone. Some embodiments include one or more climate sensors 140s that output signals indicative of the one or more climate settings. Upon adjustment, or upon indicating the adjusted climate settings are to be saved using the one or more user input devices 109, the system 102 may, based on logic executed by the one or more processors 105 and the signal output by the one or more climate sensors 140s, memorize and save the adjusted climate control settings on the one or more memory modules 106 as at least one of the one or more occupant preference settings. The climate settings may then be associated with the particular recognized vehicle occupant and the assigned vehicle zone. Hence, when the particular vehicle occupant re-enters the vehicle at a subsequent time, the system 102, based on logic executed by the one or more processors 105, may, upon recognizing the particular vehicle occupant and determining a vehicle zone of particular vehicle occupant, execute logic to automatically adjust climate settings of the vehicle and/or vehicle zone to the previously saved climate settings associated with the particular vehicle occupant and/or the particular vehicle zone. In some embodiments, different climate settings may be associated with the recognized vehicle occupant for each vehicle zone. For example, when the recognized vehicle occupant is in the driver zone 180, the recognized vehicle occupant may prefer different climate settings than if the recognized vehicle occupant was in one of the passenger zones 181, 182.

The system 102 may further include an entertainment control system 145 communicatively coupled over the communication path 104 to other modules of the system 102. The entertainment control system 145 may be any system or object configured to control various vehicle entertainment modules. As such, the entertainment control system 145 may include a disc player, a radio antenna, one or more video displays, one or more speakers, and the like to provide entertainment to the occupants of the vehicle 100. Some embodiments include one or more entertainment sensors 145s that output signals indicative of the one or more entertainment settings. The one or more occupant preference settings may include preferred entertainment settings. Preferred entertainment settings may automatically be saved and associated with a particular recognized vehicle occupant upon adjustment of the preferred entertainment setting or may be manually saved using the one or more user input devices 109. In either case, upon entering the vehicle 100 and being recognized by the system 102, the preferred entertainment settings of the one or more occupant preference settings associated with the particular recognized vehicle occupant may play. In some embodiments, different vehicle zones may have separate entertainment control systems 145. In such embodiments, the preferred entertainment settings of the one or more occupant preference settings may also be associated with the particular vehicle zone of the recognized vehicle occupant.

As noted herein, the system 102 may further include a steering wheel 116 communicatively coupled over the communication path 104 to other modules of the system 102. The steering wheel 116 may be adjustable such that a position of the steering wheel 116 relative to a vehicle occupant of the vehicle 100 is adjustable. A preferred steering wheel position setting may automatically be saved as one of the one or more occupant preference settings and associated with the particular recognized vehicle occupant upon adjustment of the steering wheel position setting or upon manually saving the steering wheel position setting using the one or more user input devices 109. In either case, upon entering the vehicle 100 and being recognized by the system 102, the steering wheel 116 may automatically be positioned at the preferred steering wheel position setting of the recognized vehicle occupant. As such, the steering wheel 116 may have an actuator 116a controlled by the one or more processors 105 to automatically move the steering wheel 116 to the preferred position in accordance with the preferred steering wheel position setting of the recognized occupant. Some embodiments include one or more steering wheel sensors 116s that output signals indicative of the position of the steering wheel. In some embodiments, adjustment of the steering wheel 116 may only occur when the recognized vehicle occupant is determined to be within the driver zone 180.

As noted herein, the system 102 may further include vehicle pedals 136 communicatively coupled over the communication path 104 to other modules of the system 102. The vehicle pedals 136 may be adjustable such that a position of the vehicle pedals 136 relative to a vehicle occupant of the vehicle 100 is adjustable. A preferred vehicle pedal position setting may automatically be saved as one of the one or more occupant preference settings and associated with the particular recognized vehicle occupant upon adjustment of the vehicle pedal position setting or upon manually saving the vehicle pedal position setting using the one or more user input devices 109. In either case, upon entering the vehicle 100 and being recognized by the system 102, the vehicle pedals 136 may automatically be positioned at the preferred vehicle pedal position setting of the recognized vehicle occupant. As such, the vehicle pedals 136 may have an actuator 136a controlled by the one or more processors 105 to automatically move the vehicle pedals 136 to the preferred position in accordance with the preferred vehicle pedal position setting of the recognized occupant. Some embodiments include one or more one or more pedal sensors 136s that output signals indicative of the position of the vehicle pedals 136. In some embodiments, adjustment of the vehicle pedals 136 may only occur when the recognized vehicle occupant is determined to be within the driver zone 180.

Still referring to FIG. 1, the system 102 may further include one or more vehicle lights 160 communicatively coupled over the communication path 104 to other vehicle modules. The one or more vehicle lights 160 may include display backlights, instrument lights, interior lighting, and the like. These various vehicle lights 160 may be adjustable by the one or more vehicle occupants to a preferred vehicle light setting. Some embodiments include one or more light sensors 160s that output signals indicative of the light settings of the one or more vehicle lights 160. As such, the one or more occupant preference settings may include preferred vehicle light settings. Preferred vehicle light settings may automatically be saved and associated with a particular recognized vehicle occupant upon adjustment of the preferred vehicle light setting or may be manually saved using the one or more user input devices 109. In either case, upon entering the vehicle 100 and being recognized by the system 102, the preferred lighting setting of the one or more occupant preference settings associated with the particular recognize occupant may automatically be set to the preferred lighting settings of the recognized occupant. In some embodiments, different vehicle zones may have separately controllable vehicle lights 160. In such embodiments, the preferred lighting settings of the one or more occupant preference settings may also be associated with the particular vehicle zone of the recognized vehicle occupant.

The system 102 may further include one or more vehicle mirrors 150 (e.g., side mirrors 151A, rearview mirror 151B, and the like shown in FIG. 2). The one or more vehicle mirrors 150 may be communicatively coupled over the communication path 104 to other modules of the system 102. The one or more vehicle mirrors 150 may be adjustable to a preferred mirror position setting such that a position of the one or more vehicle mirrors 150 may be adjusted relative to a vehicle occupant, preferably the driver. A preferred mirror position setting may automatically be saved as one of the one or more occupant preference settings and associated with the particular recognized vehicle occupant upon adjustment of the position of the one or more vehicle mirrors 150 or upon manually saving the position of the one or more vehicle mirrors 150 using the one or more user input devices 109. In either case, upon entering the vehicle 100 and being recognized by the system 102, the one or more vehicle mirrors 150 may automatically be positioned at the preferred mirror position setting of the recognized vehicle occupant. As such, the one or more vehicle mirrors 150 may have an actuator 150a controlled by the one or more processors 105 to automatically move the one or more vehicle mirrors 150 to the preferred mirror position setting in accordance with the preferred mirror position setting of the recognized occupant. Some embodiments include one or more vehicle mirror sensors 150s that output signals indicative of the position of the one or more vehicle mirrors 150. In some embodiments, adjustment of the one or more vehicle mirrors 150 may only occur when the recognized vehicle occupant is determined to be within the driver zone 180.

As noted herein, some of the one or more vehicle settings may only be adjusted to the preferred occupant preference settings of the recognized vehicle occupant when the recognized vehicle occupant is determined to be within a particular vehicle zone. For example, and not as a limitation, only when the recognized vehicle occupant is positioned within the driver zone 180 may the steering wheel 116, the vehicle pedals 136, and the one or more vehicle mirrors 150, and/or the one or more vehicle lights 160, be automatically adjusted in accordance with the one or more occupant preference settings of the recognized vehicle occupant within the driver zone 180.

Because some of the one or more vehicle settings may be a shared setting throughout the vehicle 100, for example climate control settings, vehicle entertainment settings, vehicle lighting settings, and the like, the system 102, based on logic executed by the one or more processors 105, may recognize a primary vehicle occupant of the one or more vehicle occupants. As such, in some embodiments, where a conflict between the one or more occupant preferences settings associated with the primary vehicle occupant and the one or more occupant preference settings associated with a secondary vehicle occupant occurs, the conflict is automatically resolved in favor or the primary vehicle occupant. The primary vehicle occupant may be recognized by the system 102 based on a variety a characteristics. For example, and not as a limitation, the primary vehicle occupant may be based on a door 171 the vehicle occupant entered the vehicle 100 through, and a side of the vehicle 100 at which the vehicle occupant is recognized, and/or a zone in which the one or more vehicle occupants is located. For example, an occupant recognized in the driver zone 180 may be recognized as the primary vehicle occupant. In another embodiment, the primary vehicle occupant may be user defined. For example, a vehicle occupant using the one or more user input devices 109 may define a particular vehicle occupant as the primary vehicle occupant (e.g., himself or herself or another individual). In yet further embodiments, a particular recognized vehicle occupant may be a primary vehicle occupant for some vehicle settings while another recognized vehicle occupant may be a primary vehicle occupant for other vehicle settings. For example, a first primary vehicle occupant may be a primary vehicle occupant for vehicle entertainment settings while a second primary vehicle occupant may be a primary vehicle occupant for the remaining vehicle settings.

Still referring to FIG. 1, the system may further include one or more vehicle status sensors 170 communicatively coupled over the communication path 104 to other vehicle modules. The one or more vehicle status sensors 170 may be any sensor configured to output a vehicle status signal. The vehicle status signal may be a signal indicative of an intent of an occupant to enter vehicle 100 of the one or more vehicle occupants are located within the vehicle 100. For example, the vehicle status signal may include a signal indicative of the vehicle being unlocked, of a door 171 being opened and/or closed, and/or of the vehicle being started. In some embodiments, the occupant location signal received from the one or more occupant location sensors 115 may also be indicative of the vehicle status. Upon receiving a vehicle status signal of the intent of the vehicle to be entered or that one or more vehicle occupants are within the vehicle 100, the system 102 may execute a method of adjusting the one or more vehicle settings. In some embodiments, recognition of the one or more vehicle occupants may begin before the one or more vehicle occupants have entered the vehicle 100.

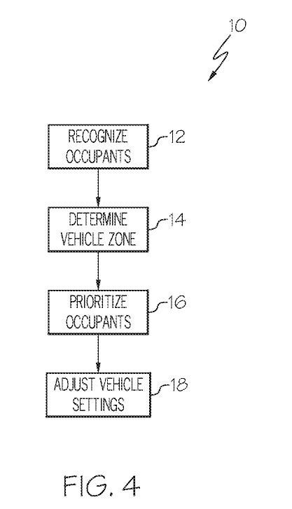

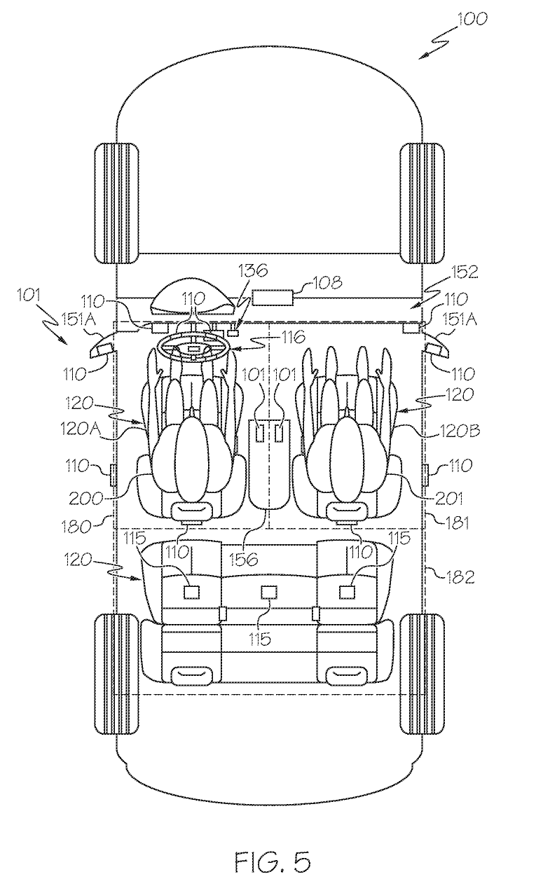

Referring now to FIG. 4, a method 10 of adjusting one or more vehicle settings is generally depicted. The method 10 will be further described in conjunction with FIG. 5. When initiated, the system 102, based on logic executed by the one or more processors, may recognize one or more vehicle occupants (block 12) within or entering the vehicle 100 based on a signal output by the one or more occupant recognition sensors 110. Referring to FIG. 5, FIG. 5 schematically illustrates a vehicle 100 with a first vehicle occupant 200 and a second vehicle occupant 201 located therein. As described herein the one or more occupant recognition sensors 110 may automatically capture data relevant to the recognition of the vehicle occupants 200, 201, or the vehicle occupants 200, 201 may be prompted to interact with the one or more occupant recognition sensors 110 to allow the one or more occupant recognition sensors 110 to collect data to recognize the vehicle occupants 200, 201. The system 102, based on the occupant recognition signal output by the one or more occupant recognition sensors 110 may match characteristics of the vehicle occupants 200, 201 to a database of characteristics of one or more vehicle occupants 200, 201 to recognize the identity of each of the particular vehicle occupant. Referring to the example illustrated in FIG. 5 the system 102 may recognize a first vehicle occupant 200 and a second vehicle occupant 201. In some embodiments, such as where the system 102 is unable to match the occupant recognition signal to a vehicle occupant memorized within the one or more memory modules 106, the system 102 may prompt the new vehicle occupant to enter and save his or her identifying information. In other embodiments, the system 102 may automatically begin saving vehicle settings as one or more occupant preference settings of the unidentified vehicle occupant for later identified of that particular vehicle occupant.

Referring again to FIG. 4, the method 10 may further include determining a vehicle zone in which the one or more recognized vehicle occupants (block 14) are located. As described herein, based on information from the one or more occupant recognition sensors 110 and/or the one or more occupant location sensors 115, the system 102, based on logic executed by the one or more processors 105, may determine the vehicle zone in which the one or more recognized vehicle occupants are located. Referring again to FIG. 5, the first vehicle occupant 200 may be determined to be located in the first vehicle zone, in this case the driver zone 180, and the second vehicle occupant 201 may be determined to be located in the second vehicle zone, in this case the front passenger zone 181.

As noted herein, in some embodiments the system 102, based on logic executed by the one or more processors 105, may prioritize the various occupant within a vehicle 100 by recognizing a primary vehicle occupant and a secondary vehicle occupant (block 16). As described herein the primary vehicle occupant may be based on a position within the vehicle that the primary vehicle occupant is recognized, a door 171 that the primary vehicle occupant entered the vehicle through, a side of the vehicle 100 at which the primary vehicle occupant was first recognized, or the primary vehicle occupant may be user defined. In some embodiments, there may not be a step of prioritizing vehicle occupants.

The method 10 further includes the step of automatically adjusting one or more vehicle settings based on one or more occupant preference settings associated with the recognized vehicle occupants and the determined vehicle zones of the recognized vehicle occupants (block 18). As described herein, the one or more occupant preference settings may be based on a memorized occupant preference settings previously set by the recognized vehicle occupant and associated with a particular vehicle zone. Hence, the system 102, based on logic executed by the one or more processors 105, may adjust one or more vehicle settings in accordance with the one or more occupant preference settings of the first vehicle occupant 200 that are associated with a determined vehicle zone of the first vehicle occupant 200 and the one or more occupant preference settings of the second vehicle occupant 201 that are associated with a determined vehicle zone of the second vehicle occupant 201. As such, the one or more occupant preference settings may be associated with the particular vehicle zone (e.g., driver zone 180, front passenger zone 181, and rear passenger zone 182) in which the recognized vehicle occupant is located.

Referring to FIG. 5, the system 102, based on at least one of the occupant recognition signals output by the one or more occupant recognition sensors 110 and, in some embodiments, the occupant location signal output by the one or more occupant location sensors 115, may determine that the first vehicle occupant 200 is located within the driver zone 180 and the second vehicle occupant 201 is located within the front passenger zone 181. The first vehicle occupant 200 may have a first one or more occupant preference settings that may be associated with the driver zone 180 (e.g., seat settings, climate settings, pedal position settings, steering wheel position settings, mirror position settings, etc.). Similarly, the second vehicle occupant 201 may have a first one or more vehicle preference settings associated with the front passenger zone 181 (e.g., seat settings, climate control settings, etc.). If the first and second vehicle occupants 200, 201 were to switch seats, the first vehicle occupant 200 would be determined to be located within the front passenger zone 181 and the second vehicle occupant 201 would be determined to be located within the driver zone 180. In this case, the system 102, based on logic executed by the one or more processors, would adjust the vehicle settings in both the driver zone 180 and the passenger zone 181 to suit the one or more occupant preference settings of the first and second vehicle occupants 200, 201 within his or her particular vehicle zones. For example, the first vehicle occupant 200 may have a second one or more occupant preference settings that may be associated with the passenger zone 181 (e.g., seat settings, climate control settings, etc.) and the second vehicle occupant 201 may have a second one or more occupant preference settings that may be associated with the driver zone 180 (e.g., seat settings, climate settings, pedal position settings, steering wheel position settings, mirror position settings, etc.). The first one or more occupant preference settings of the first vehicle occupant 200 may be different from the second one or more occupant preference settings of the first vehicle occupant 200. Similarly, the first one or more occupant preference settings of the second vehicle occupant 201 may be different from the second one or more occupant preference settings of the second vehicle occupant 201. Furthermore, both the first and second vehicle occupants may have a third occupant preference setting that may be associated with a rear occupant zone 182.

As noted hereinabove, wherein the one or more occupant preference settings of the recognized vehicle occupants 200, 201 conflict with one another, priority may be given to at least one of the one or more recognized vehicle occupants 200, 201. Specifically, as described above, a primary vehicle occupant may be determined of the one or more vehicle occupants 200, 201 such that conflicting occupant preference settings between the first and second vehicle occupants 200, 201 may be resolved in favor of the primary vehicle occupant.

In further embodiments, upon identifying the one or more vehicle occupants 200, 201, the system 102, based on logic executed by the one or more processors 105, may provide personalized greetings to at least one of the one or more vehicle occupants. Such personalized greetings may be delivered to the one or more vehicle occupants through the entertainment control system 145 and/or the display 108 of the vehicle 100.

It should be now be understood that systems and methods for adjusting one or more vehicle settings include adjusting a variety of vehicle settings based on recognizing one or more vehicle occupants within the vehicle. As such, one or more occupant preference settings associated with the one or more recognized vehicle occupants may cause the various vehicle settings to be automatically adjusted to suit the preferences of the one or more vehicle occupants. Furthermore, the one or more vehicle occupants may have differing occupant preference settings depending on the vehicle zone in which the occupant is positioned within the vehicle. For example, a vehicle occupant may have different preference settings when within a driver zone of a vehicle than when within a passenger zone of the vehicle. Hence if the vehicle occupant is in the driver zone, occupant preference settings associated with that vehicle occupant includes preference settings specific to the driver zone. If instead, the same vehicle occupant is within a passenger zone of the vehicle, the one or more occupant preference settings associated with that vehicle occupant includes preference setting specific to the passenger zone of the vehicle. Furthermore, systems and methods according to the present disclosure can adjust various zones for various recognized occupants simultaneously allowing for a more customized experience for drivers and passengers alike.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A system for adjusting one or more vehicle settings, the system comprising:
one or more processors;
one or more occupant recognition sensors communicatively coupled to the one or more processors and configured to output an occupant recognition signal indicative of an identity of one or more vehicle occupants; and
one or more memory modules communicatively coupled to the one or more processors, the one or more memory modules storing logic that when executed by the one or more processors, cause the system to:
recognize a first vehicle occupant of the one or more vehicle occupants based on the occupant recognition signal output by the one or more occupant recognition sensors;
determine a first vehicle zone of a vehicle in which the first vehicle occupant is present, wherein the first vehicle zone is one of a driver zone, a front passenger zone, and a rear passenger zone;
determine a priority of the first vehicle occupant; and
automatically adjust the one or more vehicle settings based on one or more occupant preference settings associated with the first vehicle occupant, the first vehicle zone, and the priority of the first vehicle occupant.

2. The system of claim 1, wherein the one or more occupant recognition sensors comprise at least one of a fingerprint recognition sensor and a facial recognition sensor.

3. The system of claim 1, further comprising one or more user input devices communicatively coupled to the one or more processors that allow the one or more vehicle occupants to input and save the one or more occupant preference settings on the one or more memory modules.

4. The system of claim 1, wherein the one or more processors execute logic to cause the system to memorize the one or more occupant preference settings for each of the one or more vehicle occupants upon adjustment by the one or more vehicle occupants of the one or more vehicle settings.

5. The system of claim 1, wherein the first vehicle zone of the first vehicle occupant is determined based on at least one of where the first vehicle occupant is located within the vehicle, a door through which the first vehicle occupant entered the vehicle, and a side of the vehicle at which the first vehicle occupant is recognized.

6. The system of claim 1, wherein the one or more vehicle settings include at least one of seat settings, steering wheel position settings, pedal position settings, climate settings, entertainment settings, and mirror position settings.

7. The system of claim 1, wherein logic executed by the one or more processors further cause the system to:
recognize a second vehicle occupant of the one or more vehicle occupants based on the occupant recognition signal output by the one or more occupant recognition sensors;
determine a second vehicle zone of the vehicle in which the second vehicle occupant is positioned, wherein the second vehicle zone is at least one of the driver zone, the front passenger zone, and the rear passenger zone;
determine a priority of the second vehicle occupant;
prioritize the first vehicle occupant and the second vehicle occupant based on the priority of the first vehicle occupant and the second vehicle occupant such that one of the first vehicle occupant and the second vehicle occupant is a primary vehicle occupant and one of the first vehicle occupant and the second vehicle occupant is a secondary vehicle occupant; and
automatically adjust the one of more vehicle settings based on the one or more occupant preference settings associated with the second vehicle occupant and the second vehicle zone, wherein a conflict between the one or more occupant preference settings associated with the primary vehicle occupant and the one or more occupant preference settings associated with the secondary vehicle occupant are resolved in favor of the primary vehicle occupant.

8. A system for adjusting one or more vehicle settings, the system comprising:
one or more processors;
one or more occupant recognition sensors communicatively coupled to the one or more processors and configured to output an occupant recognition signal indicative of an identity of one or more vehicle occupants; and
one or more memory modules communicatively coupled to the one or more processors, the one or more memory modules storing logic that when executed by the one or more processors, cause the system to:
recognize a first vehicle occupant of the one or more vehicle occupants based on the occupant recognition signal output by the one or more occupant recognition sensors;
determine a first vehicle zone of a vehicle in which the first vehicle occupant is present, wherein the first vehicle zone is one of a driver zone and a passenger zone;
determine a priority of the first vehicle occupant; and
automatically adjust the one or more vehicle settings based on one or more occupant preference settings associated with the first vehicle zone, the first vehicle occupant, and the priority of the first vehicle occupant wherein:
when the first vehicle zone is the driver zone, the one or more vehicle settings are adjusted to a first one or more occupant preference settings associated with the first vehicle occupant and the driver zone; and
when the first vehicle zone is the passenger zone, the one or more vehicle settings are adjusted to a second one or more occupant preference settings associated with the first vehicle occupant and the passenger zone, wherein the first one or more occupant preference settings are different from the second one or more occupant preference settings.

9. The system of claim 8, wherein the one or more occupant recognition sensors comprise at least one of a fingerprint recognition sensor and a facial recognition sensor.

10. The system of claim 8, further comprising one or more user input devices communicatively coupled to the one or more processors that allow the one or more vehicle occupants to input and save the one or more occupant preference settings on the one or more memory modules.

11. The system of claim 8, wherein:
the one or more processors execute logic to cause the system to memorize the first one or more occupant preference settings for the first vehicle occupant upon adjustment by the first vehicle occupant of the one or more vehicle settings within the driver zone; and
the one or more processors execute logic to cause the system to memorize the second one or more occupant preference settings for the first vehicle occupant upon adjustment by the first vehicle occupant of the one or more vehicle settings within the passenger zone.

12. The system of claim 8, wherein the first vehicle zone of the first vehicle occupant is determined based on at least one of where the first vehicle occupant is located within the vehicle, a door through which the first vehicle occupant entered the vehicle, and a side of the vehicle at which the first vehicle occupant is recognized.

13. The vehicle of claim 8, wherein the one or more vehicle settings include at least one of: seat settings, steering wheel position settings, pedal position settings, climate settings, entertainment settings, and mirror position settings.

14. The system of claim 8, wherein logic executed by the one or more processors further cause the system to:
recognize a second vehicle occupant of the one or more vehicle occupants based on the occupant recognition signal output by the one or more occupant recognition sensors;
determine a second vehicle zone of the vehicle in which the second vehicle occupant is present, wherein the second vehicle zone is one of the driver zone and the passenger zone;
determine a priority of the second vehicle occupant;
prioritize the first vehicle occupant and the second vehicle occupant based on the priority of the first vehicle occupant and the second vehicle occupant such that one of the first vehicle occupant and the second vehicle occupant is a primary vehicle occupant and one of the first vehicle occupant and the second vehicle occupant is a secondary vehicle occupant; and
automatically adjust the one of more vehicle settings based on the one or more occupant preference settings associated with the second vehicle occupant and the second vehicle zone, wherein a conflict between the one or more occupant preference settings associated with the primary vehicle occupant and the one or more occupant preference settings associated with the secondary vehicle occupant are resolved in favor of the primary vehicle occupant.

15. The system of claim 14, wherein which of the first and second vehicle occupants is the primary vehicle occupant is determined based on at least one of: a user defined primary vehicle occupant, where the primary vehicle occupant is located within the vehicle, a door the primary vehicle occupant entered the vehicle through, and a side of the vehicle at which the primary vehicle occupant is recognized.

16. A method for adjusting one or more vehicle settings, the method comprising:
recognizing a first vehicle occupant of one or more vehicle occupants with one or more occupant recognition sensors;
determining a first vehicle zone of a vehicle in which the first vehicle occupant is present, wherein the first vehicle zone is one of a driver zone; a front passenger zone, and a rear passenger zone;
determining a priority of the first vehicle occupant; and
automatically adjusting the one or more vehicle settings based on one or more occupant preference settings associated with the first vehicle occupant, the first vehicle zone, and the priority of the first vehicle occupant.

17. The method of claim 16, further comprising memorizing the one or more occupant preference settings for each of the one or more vehicle occupants upon adjustment by the one or more vehicle occupants of the one or more vehicle settings.

18. The method of claim 16, wherein the first vehicle occupant is assigned to a vehicle zone based on at least one of where the first vehicle occupant is located within the vehicle, a door the first vehicle occupant entered the vehicle through, and a side of the vehicle at which the first vehicle occupant is recognized.

19. The method of claim 16, further comprising:
recognizing a second vehicle occupant of the one or more vehicle occupants;
assigning a second vehicle zone to the second vehicle occupant, wherein the second vehicle zone is one of the driver zone; the front passenger zone, and the rear passenger zone;
determining a priority of the second vehicle occupant; and
automatically adjusting the one or more vehicle settings based on the one or more occupant preference settings associated with the second vehicle occupant and the second vehicle zone.

20. The method of claim 19, further comprising prioritizing the first vehicle occupant and the second vehicle occupant based on the priority of the first vehicle occupant and the second vehicle occupant such that one of the first vehicle occupant and the second vehicle occupant is a primary vehicle occupant and one of the first vehicle occupant and the second vehicle occupant is a secondary vehicle occupant, wherein a conflict between the one or more occupant preference settings associated with the primary vehicle occupant and the one or more occupant preference settings associated with the secondary vehicle occupant are resolved in favor of the primary vehicle occupant.
